(19) United States
(12) Patent Application Publication
(10) Pub. No.: US 2009/0049946 A1
(43) Pub. Date: Feb. 26, 2009

(54) Ricky braking system for zipline riders

(76) Inventor: Richard Barrett Buckman, Perkiomenville, PA (US)

Correspondence Address: Richard Barrett Buckman, 2817 Yost Rd, Perkiomenville, PA, 18074, US

(21) Appl. No.: 12/215,061

(22) Filed: Jun. 26, 2008

Related U.S. Application Data
(60) Provisional application No. 60/965,571, filed on Aug. 22, 2007.

(51) Int. Cl. F16C 1/10

(52) U.S. Cl. 74/502.2

(57) ABSTRACT

The Ricky Braking System for Zipline Riders is a new method of braking and controlling rider's speed on ziplines. The Ricky Braking System for Zipline Riders is a dual cable zipline design that utilizes pulleys and counterweights to safely bring the rider to a complete stop. Because the rider is not required to use an active braking method, such as leather gloves rubbed on the cable to provide friction, and the rider is not brought to an abrupt stop such as ziplines using stop blocks, my invention improves safety and comfort of zipline riders.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Ziplines were originally invented for biologists and researchers to study tree canopies in Costa Rica. Today “Canopy Tours” consisting of one or more ziplines have transcended their utilitarian status and are now being implemented worldwide as a recreational activity in camps and adventure parks.

A zipline is a heavy cable stretched between two anchors such as trees. An incline is created by securing the start end higher than the finish end. A carriage or trolley is attached to start end of the cable and gravity brings the zip rider down the cable. The problem with ziplines is that the rider can travel at high speeds down the cable and must come to a complete stop before reaching the end or suffer injury. Currently available braking or speed controlling methods are problematic or unsafe. Many zipline courses or canopy tours use leather gloves to grab the cable, thus providing friction and slowing down the rider. This is unsafe for many reasons. Gloves can tear or heat up causing the rider to let go of the cable and thus running into the tree at the end of the cable and suffering injury. Other courses employ stop blocks at the ends of their zipline cables. These often lead to an abrupt stop to the ride and can also cause injury.

I have invented a mechanism which brings riders to a gradual stop at the end of their ride. My invention will vastly improve safety and comfort to ziplines and canopy tours.

### BRIEF SUMMARY OF THE INVENTION

My invention, the Ricky Braking System for Zipline Riders, solves the problematic braking dilemmas inherent to zipline design. Two cables are tensioned between the two trees or anchors. One cable is the riding cable and the other cable serves to hold the brake anchor. The brake anchor is located roughly ⅔^{rds} of the way down the zipline. The rider rides freely for the first ⅔rds of the cable and then is gradually slowed for the final ⅓^{rd} until coming to a complete stop at the end of the ride. The brake anchor holds a pulley through which a rope is run down to the riding cable. The end of the rope is attached to another pulley which is fastened to the riding cable. The other end of the rope is routed down to the receiving platform and is attached to counterweights. When the rider hits the braking pulley, the rope is pulled through the anchor and the counterweights act to slow the rider's progress. A guide can apply additional friction to the rope to further slow the rider.

### BRIEF DESCRIPTION OF THE SEVERAL VIEWS OF THE DRAWINGS

FIG. 1—Overview illustrating a side view of the entire system

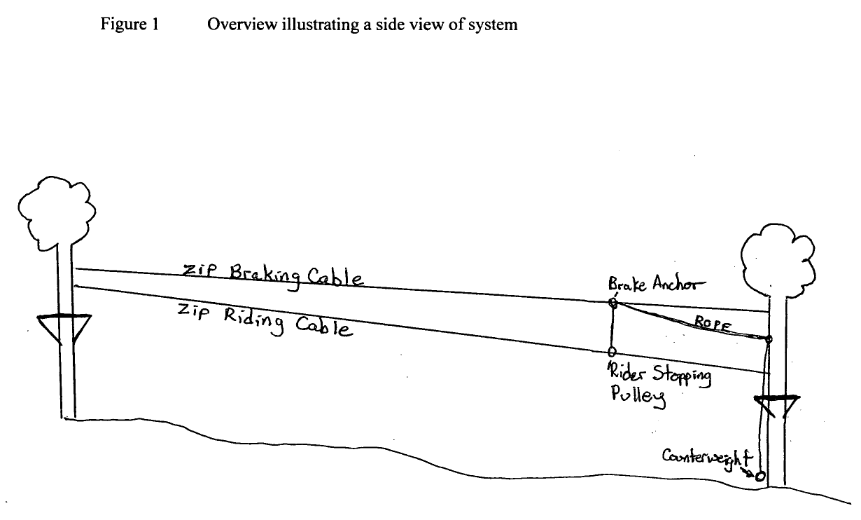

FIG. 2—Illustrates how a rider's descent would look

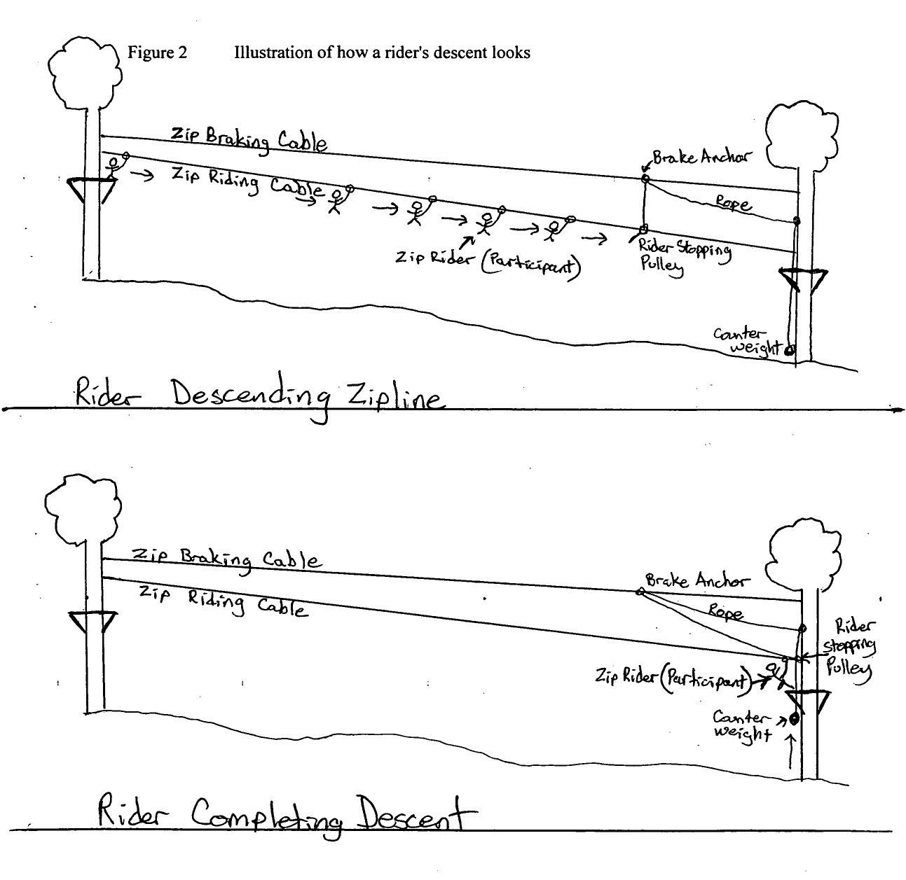

FIG. 3—Detail/exploded view of Brake Anchor

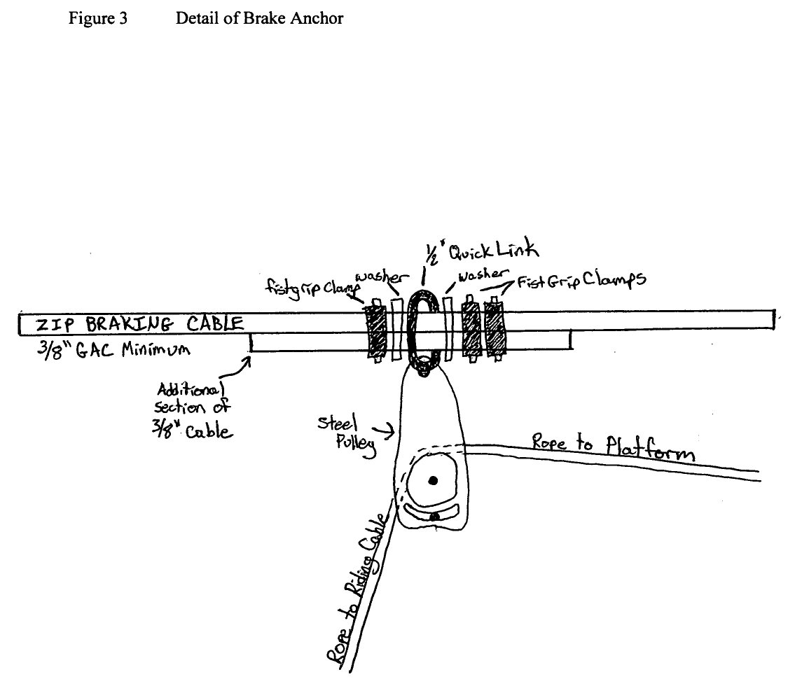

FIG. 4—Detail/exploded view of Rider Stopping Pulley

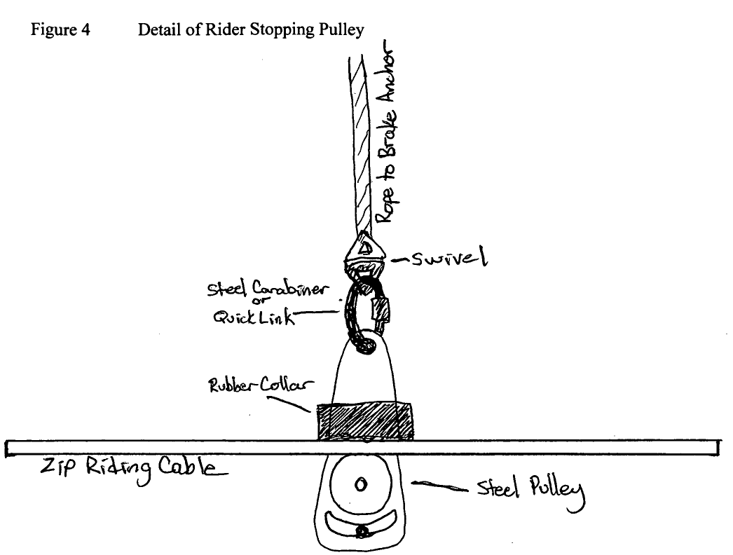

FIG. 5—Detail of counterweight system

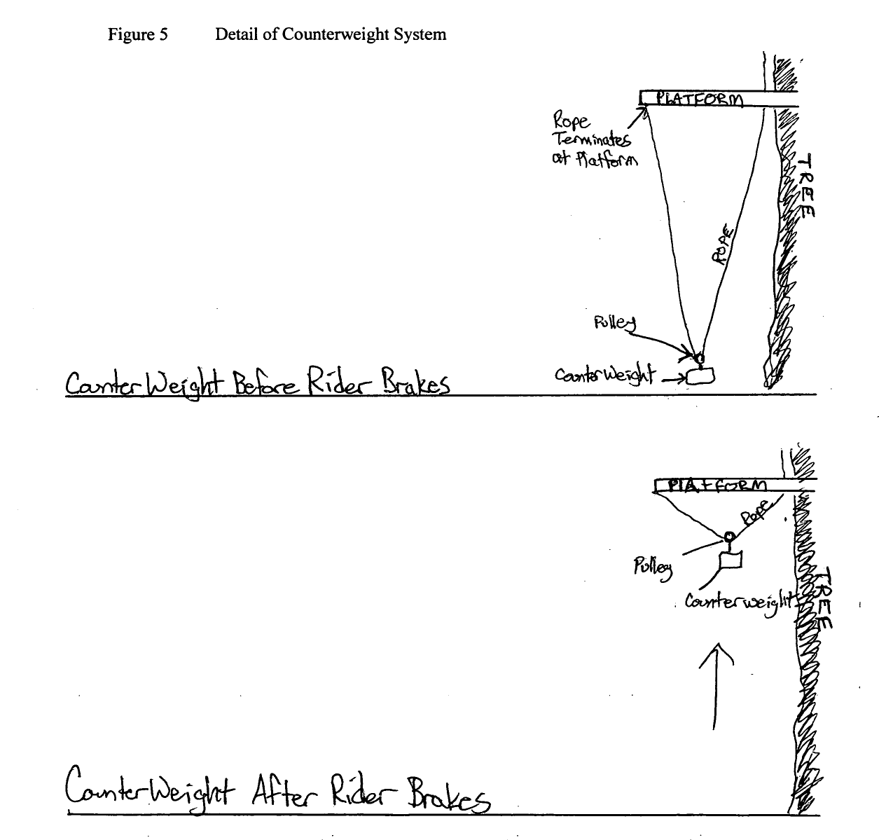

### DETAILED DESCRIPTION OF THE INVENTION

The Ricky Braking System is a method of controlling and ultimately stopping a rider's descent down a zipline. A zipline is created by tensioning a cable between two fixed anchors such as trees. The zipline cable and attachment methods must adhere to ACCT standards. For the Ricky Braking System use a minimum of 7×19⅜″ galvanized aircraft cable for both the riding and braking cable. To create the anchor on the braking cable one needs to install a ½″ or better quick link on the braking cable 70 to 75% of the way down the cable. The quick link should be sandwiched by washers and held secure by a minimum of two fist grip clamps in front of the washers. The quick link holds a steel pulley with a minimum braking strength of 10000 lbs. complete with backup. Through this pulley a NFPA certified rope is routed down to an identical pulley which is attached to the riding cable. The other end of the rope leaves the anchor and goes to the finish platform. The rope is run through a quick link which is attached to the tree between the termination points of the riding and braking cables. From the quick link the rope is run down through the platform and secured to the counterweights. The counterweights should be heavy enough to keep tension on the rope to prevent knots but light enough as to not prevent your lightest rider from making it to the end of the zip. A guide working the end of the zip can apply friction to the moving rope by using gloved hands and lightly gripping the rope to slow heavier riders.

The zip rider begins his descent down the zip, riding freely the first ⅔rds of the way. Upon hitting the braking pulley with his zip trolley, the rider pushes the braking pulley with his zip trolley for the remaining distance down the zip. Pushing the braking pulley causes it to pull the rope through the braking pulley attached to the braking cable above. This causes the rope to pull the counterweights up and slow the rider.

1. The Ricky Braking System for Zipline Riders is a dual cable zipline braking system that utilizes pulleys and counterweights to safely bring the rider to a gradual and complete stop. The Ricky Braking System for Zipline Riders is a braking method superior to all others in that it is safer and more comfortable while also allowing riders to travel at full speed for the majority of their descent down the cable before bringing them to a gradual and complete stop at the end of their ride.
